(19) United States
(12) Patent Application Publication
(10) Pub. No.: US 2008/0101255 A1
(43) Pub. Date: May 1, 2008

(54) Automatic Tracking Of Network Paramenters In The Event Of Changes In The Traffic Load

(76) Inventors: Joachim Charzinski, Munchen (DE); Claus Gruber, Munchen (DE); Uwe Walter, Weingarten (DE); Martin Winter, Rosenheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/663,050

(22) PCT Filed: Sep. 8, 2005
(86) PCT No.: PCT/EP05/54438

§ 371 Date: Mar. 15, 2007

(30) Foreign Application Priority Data
Sep. 22, 2004 (DE) 10 2004 045 980.0

(51) Int. Cl. G06F 11/30

(52) U.S. Cl. 370/252

(57) ABSTRACT

In one aspect method and device for tracking network parameters of a communications network, which is formed by links, with access controls for the purpose of limiting the traffic load are provided. The traffic matrix of the network is regularly determined and probabilities of the blocking of traffic are determined based on the traffic matrix. If the blocking probabilities exceed a criterion, typically a maximum blocking probability, the access controls are oppositely controlled in an automatic manner by resetting the limits for the access controls. This resetting can precede a resetting of link weights for optimizing the distribution of traffic in the network. Automatic continuous adaptation of network parameters for optimizing the probability of authorization is enabled for the traffic flows to be transmitted.

### CROSS REFERENCE TO RELATED APPLICATIONS

This application is the US National Stage of International Application No. PCT/EP2005/054438, filed Sep. 8, 2005 and claims the benefit thereof. The International Application claims the benefits of German application No. 102004045980.0 DE filed Sep. 22, 2004, both of the applications are incorporated by reference herein in their entirety.

### FIELD OF INVENTION

The invention relates to a method and device for tracking network parameters of a communications network, which is formed by links with access controls for the purpose of limiting the traffic load.

### BACKGROUND OF INVENTION

One of the most important developments in the field of networks at the moment is the further development of conventional data networks or packet networks for transmissions of so-called real time traffic, i.e. voice, audio information and video signals. The guarantee of real time traffic assumes compliance with so-called quality of service features. In order to maintain the quality of service, transmitted traffic must not exceed thresholds for delay or latency, rejection of packets and jitter, i.e. fluctuations in the transmission time of individual packets. An important measure for maintaining the quality of service parameters is the traffic limitation for packet networks, via which real time traffic is to be transmitted. As a rule this traffic limitation is implemented using so-called access controls, i.e. new traffic to be transmitted must be registered and is only authorized if the authorization of this traffic is not going to cause a limit for maximum traffic to be authorized to be exceeded.

In determining limits for a traffic limiting access control, the following must be taken into consideration: the determination of the limit should, on the one hand, guarantee the desired quality of transmission, on the other hand the traffic transmitted via the network should be optimized, i.e. the probability of traffic not being authorized should be minimized as much as possible. Therefore, the determination of limits is usually modeled on the so-called traffic matrix, i.e. the volume of traffic that is to be transmitted between (peripheral) nodes in the network. The so-called blocking probability is often used as a measure for determining suitable limits, i.e. a measure for the probability that a traffic flow to be transmitted between two nodes will not be authorized or for the frequency with which such a traffic flow will be rejected. One possibility for a fair determination of limits is to determine these in such a way that the blocking probabilities for traffic flows transmitted via the net are the same for any direction. A more economic determination gives priority to traffic directions that are loaded with a high traffic volume, in order to increase the overall traffic transmitted via the network.

A change in the traffic density to be transmitted via the network and hence the traffic matrix results in a change in the blocking probabilities. This change in the blocking probabilities can result in less traffic being transmitted via the network than could be carried. Thus the operator adjusts, if necessary manually, the setting of the limits for the access controls to the changed traffic situations.

### SUMMARY OF INVENTION

An object of the invention is to optimize the transported traffic volume in a network with access controls in an efficient manner.

The object is achieved by a method and a device as claimed in the independent claims.

In accordance with the invention it is proposed to determine the traffic matrix of the network regularly and using the current, i.e. last determined traffic matrix to set at least one blocking probability. A check is then carried out to determine whether the blocking probability determined meets a criterion for a proper or scheduled network operation, e.g. is below a threshold value. If the criterion is not met, then using the current traffic matrix new values are determined anew for limits used within the framework of the access controls. This resetting is preferably carried out in line with a lowering of the blocking probability. After these values have been determined, then a check is carried out to determine whether the criterion would be met if the limits were reset to these values. If the criterion would be met, then the limits are set to these values, so that the blocking probability is lowered.

According to a further development of the subject matter of the application, if the criterion is not met, it is possible to use the current traffic matrix to determine new values for link weights or link metrics of the network in order to optimize the transport of traffic through the network. Then based on the new values for the link weights, new values can be determined for limits used within the framework of the access controls. Subsequently a check is carried out to determine whether the new values for the limits result in the criterion being met and if the criterion is met, then these values are adopted for the limits for the access controls. This method in accordance with the further development can follow on from a resetting of limits for the access control without changing link weights, if the first resetting of limits does not result in the criterion being met.

Preferably all the relevant blocking possibilities relevant for transporting traffic via the network are calculated and all said possibilities checked to determine whether a criterion is met. A resetting of limits can then be made in terms of lowering all blocking probabilities that do not meet the respective criterion.

In the lowering of the blocking probability or blocking probabilities, undertaken through the determination of new values for the limits, secondary conditions can be included, e.g. the relative sizes of the different blocking probabilities to each other.

By using different traffic classes, the invention can also be applied traffic class specific, which means, for example, that the criteria are different depending on the traffic class. When using the criteria, other parameters can also be included in addition to the blocking probability, such as the packet loss rate and measured link capacity utilization.

The invention allows automatic calculation or configuration of network parameters in terms of optimized traffic limitation. The operator does not need to use any external optimization programs, which would involve conversion of network parameters between different formats or manual adjustment of parameters. This results in a reduction in cost and effort.

An additional advantage is that the reaction to fluctuations or changes affecting the traffic is faster and more systematic. The automatic tracking of parameters according to the invention reduces the burden on the network operator in the network control centre who does not have to worry about traffic changes.

The invention can be further advantageously developed whereby changes in the topology of the network (e.g. in the event of link failures) are automatically detected and reported for the tracking of network parameters. The new topology can then be used as a basis for determining new values for the limits used for the access control. The network reacts by determining anew the limits on traffic redistributions caused by changes in topology, without the network management having to undertake adaptation measures in addition. This redetermination can occur instantaneously or with a certain delay time. A delayed reaction allows momentary changes in the topology that do not require any tracking of network parameters, to remain disregarded. A change of topology of this kind is e.g. the momentary failure of a link.

The invention can be implemented, for example, on a central network control server. Other possibilities are to locate the invention in a network management system or in a service control device. Depending on the network, it is also a good idea for the different steps or functions that occur in the method according to the invention to be distributed in the network into different network elements. By way of example, tasks can be undertaken by nodes or routers in the network or by the network elements provided for the access control.

### BRIEF DESCRIPTION OF THE DRAWINGS

The subject matter of the invention is described in more detail below within the scope of an embodiment with reference to the figures, in which:

FIG. 1 shows flowchart of a method according to the invention

FIG. 2 shows flowchart from FIG. 1 with additional input provided where there is a change in the network topology

FIG. 3 shows a schematic diagram of a network control server with the functions required for the invention

### DETAILED DESCRIPTION OF INVENTION

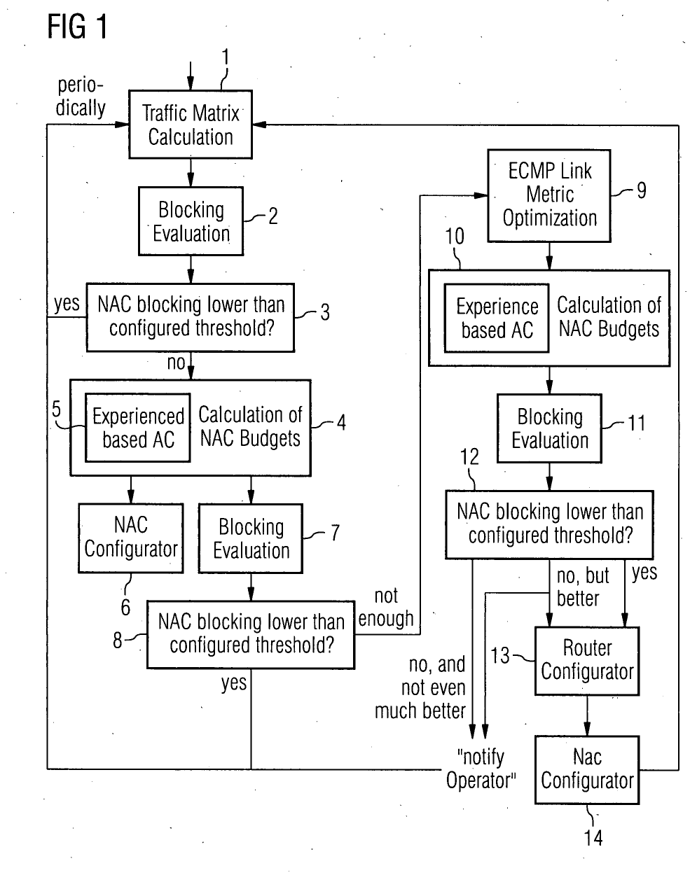

FIG. 1 shows the individual, periodically implemented steps of a method according to the invention:
1: Calculation of the traffic matrix
2: Calculation of the blocking probabilities
3: Check whether the blocking probabilities exceed threshold values. If not, after a period of time, the traffic matrix is recalculated again. If a threshold value is exceeded, continue with point 4.
4: The limits for the access controls are recalculated. The calculated limits can, in addition, be adjusted on the basis of experience values. From experience, calculated or nominal limits can be exceeded, because the traffic volume actually transmitted is generally less than that registered for transmission. From that one can derive an experience-based value for an overbooking (step 5) and adjust the limits accordingly (step 6).
5: Inclusion of an experience-based value for overbooking
6: Adjusting the limits in line with the overbooking
7: Calculation of the blocking probabilities
8: Check whether the calculated blocking probabilities are below the thresholds. If the thresholds are not exceeded, the traffic matrix is recalculated again after a period of time. Otherwise step 9 follows.
9: Reoptimization of the link metrics
10: Recalculation of the limits
11: Calculation of the blocking probabilities
12: Check whether the recalculated blocking probabilities are lower than the thresholds. If the threshold criterion is not complied with, the network management is notified. If the new limits result in improved blocking probabilities, which, for example, fulfill the threshold criterion, the routers are reconfigured in step 13.
13: Routers are configured according to the recalculated link metrics.
14: The limits for the access control are set at the recalculated values.

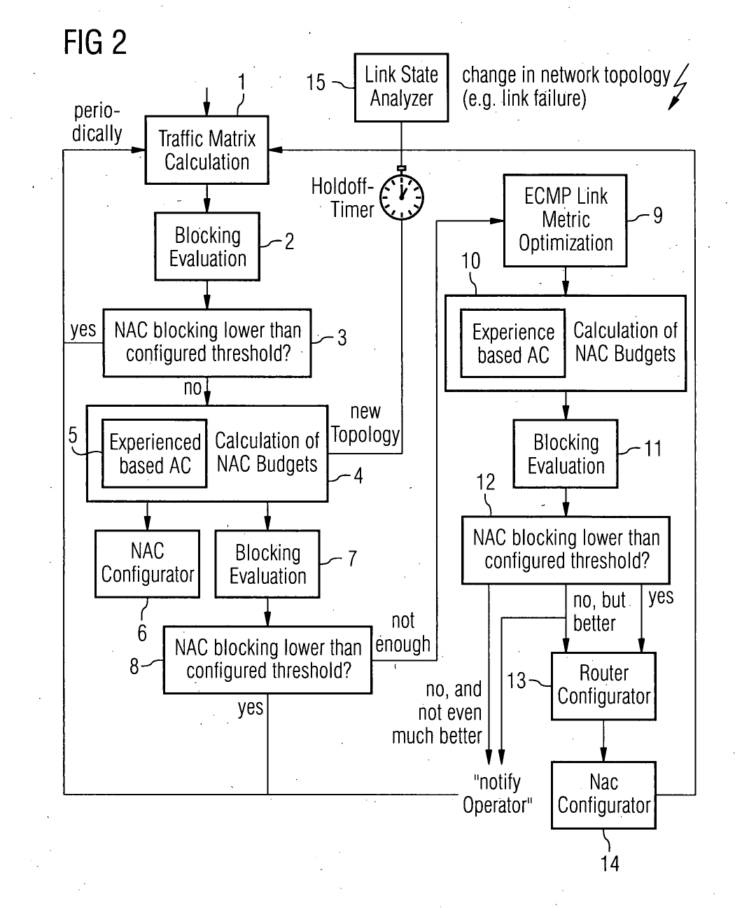

FIG. 2 shows an extension of the method corresponding to FIG. 1. Altered network topologies, e.g. in the event of link failures, can be considered in the concept described in FIG. 1 and used for the first calculation of new limits (15: topology determination).

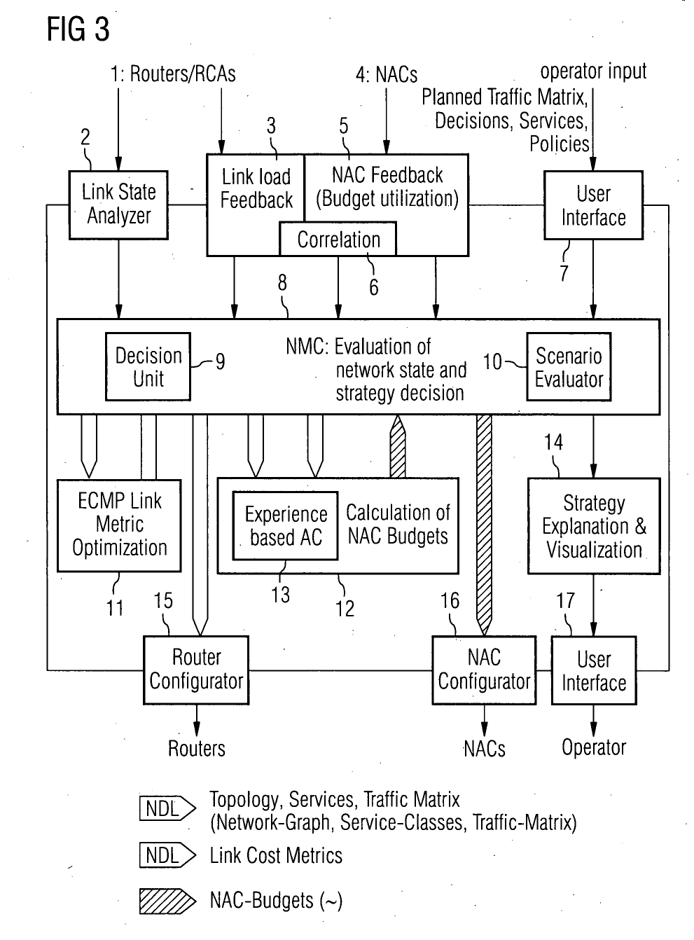

FIG. 3 shows the structure of a network control server with functions for a method according to the invention. This network control server contains three different types of input, that is input of routers of the network or so-called Router Control Agents (RCA) 1, which provide information to a module for the topology analysis 2 and to a module for controlling the link load 3. Additional input comes from the network control entities 4, which transmit the current load of the limits for the access controls and other information to a module 5 for monitoring the budget utilization. Finally there is the option of inputting planned traffic matrices, services, assessment criteria and such like via a user interface 7. A central component of the network control server is a module 8 for evaluating the operating state of the network and for strategy decisions. The entire input of the network control server—possibly in pre-processed or edited form, e.g. using a processing module 6—is routed to this module. The module contains a component for decisions to be made 9 and a component for evaluating different scenarios 10. The following information or results are then generated using the central module 8: an optimized link metric 11, recalculated limits for the access control 12, possibly adjusted by experience values 13, and an editing of the strategy with explanations 14. The network control server has the following output modules: a configurator for router 15, a configurator for limits for the access controls 16 and a user interface 17 for information to be forwarded to the network operator or the network management.

This network control server can be used to implement the methods depicted in FIG. 1 or FIG. 2. Alternatively, these methods can also be realized in other device elements, possibly in distributed form.

1.-9. (canceled)

10. A method for tracking network parameters of a communications network formed by links with access controls for the purpose of limiting the traffic load, comprising:
calculating a traffic matrix of the network;
evaluating, based on the traffic matrix, a blocking probability for traffic subjected to an access control;
determining if the blocking probability meets a criterion for a scheduled network operation;
calculating new values for limits used within the framework of the access controls in response to the not meeting the criterion;
determining using the new values if the blocking probability meets the criterion; and
setting the limits to the new values in response to meeting the criterion for the determination using the new values,
whereby the blocking probability is lowered when the limits are set to the new values.

11. The method as claimed in claim 10, further comprising in response to not meeting the criterion for the determination using the new values:
determining, using the traffic matrix, new values for link weights of the network in order to optimize a transport of traffic through the network;
evaluating new values for limits used within the framework of the access controls are based on the new values for the link weights;
determining if the criterion is met when the limits are set to the new values for the limits; and
configuring the link weights and setting the limits set to the new limit value in response to meeting the criterion.

12. The method as claimed in claim 10, wherein a network management is alerted if the criterion is not met.

13. The method as claimed in claim 10, wherein the criterion is a compliance with a threshold value.

14. The method as claimed in claim 10, wherein changes in a topology of the network are considered with the determination of new values for the limits.

15. The method as claimed in claim 14, wherein and execution of tracking network parameters is triggered by a change in the topology of the network.

16. A device with means for executing a method as claimed in one of the previous claims.
a traffic matrix of the network;
a blocking probability for traffic subjected to an access control and determined from the current traffic matrix;
a first checking unit that determines if the blocking probability meets a criterion for a scheduled network operation;
new values for limits used within the framework of the access controls that are determined if the criterion is not met via the first checking unit; and
a second checking unit that determines if the criterion is met when the limits are reset to the new values,
wherein the limits are set at the new values causing the blocking probability to be lowered.

17. The device as claimed in claim 16, wherein the device is a central control server, a network management system, a service control device, a router or an access control device.

18. The device as claimed in one of the claim 17, further comprises,
a processor; and
a communications unit for communicating with a further device.
